(19) United States
(12) Patent Application Publication
(10) Pub. No.: US 2003/0058875 A1
(43) Pub. Date: Mar. 27, 2003

(54) Infiniband work and completion queue management via head only circular buffers

(75) Inventors: Richard Louis Arndt, Austin, TX (US); David F. Craddock, New Paltz, NY (US); Thomas Anthony Gregg, Highland, NY (US); Ian David Judd, Otterbourne (GB); Gregory Francis Pfister, Austin, TX (US); Renato John Recio, Austin, TX (US); Donald William Schmidt, Stone Ridge, NY (US)

Correspondence Address: Duke W. Yee, Carstens, Yee & Cahoon, LLP, P.O. Box 802334, Dallas, TX, 75380, US

(73) Assignee: International Business Machines corporation, Armonk, NY

(21) Appl. No.: 09/961,900

(22) Filed: Sep. 24, 2001

(51) Int. Cl. H04L 12/28

(52) U.S. Cl. 370/412; 370/328

(57) ABSTRACT

A distributed computing system is provided having (host and I/O) end nodes, switches, routers, and links interconnecting these components. The end nodes use send and receive queue pairs to transmit and receive messages. The end nodes use completion queues to inform the end user when a message has been completely sent or received and whether an error occurred during the message transmission or reception process. A mechanism may implement these queue pairs and completion queues in hardware. A mechanism controls the transfer of work requests from the consumer to the channel adapter hardware using only head pointers in the hardware is described, along with a mechanism for passing work completions from the channel adapter hardware to the consumer using only tail pointers in the hardware. With this scheme the channel adapter hardware can inform the CI that a work request has been completed and provide the work completion information with just a single write to system memory. Additionally, several mechanisms are provided which can be used to improve the overall efficiency of this process under different memory configurations.

### RELATED APPLICATIONS

The present application is related to commonly assigned and co-pending U.S. patent application Ser. No. ______ (Attorney Docket No. AUS920010479US1) entitled “APPARATUS AND METHOD FOR MANAGING WORK AND COMPLETION QUEUES USING HEAD AND TAIL POINTERS”, filed on ______, and U.S. patent application Ser. No. ______ (Attorney Docket No. AUS920010478US1) entitled “INFINIBAND WORK AND COMPLETION QUEUE MANAGEMENT VIA HEAD AND TAIL CIRCULAR BUFFERS WITH INDIRECT WORK QUEUE ENTRIES”, filed on an even date herewith, and hereby incorporated by reference.

### BACKGROUND OF THE INVENTION

1. Technical Field

The present invention is directed to an improved data processing system. More specifically, the present invention is directed to an apparatus and method for efficient implementation of queue pairs and completion queues in hardware using only head pointers for the queue pairs and tail pointers for the completion queues to manage circular buffers.

2. Description of Related Art

InfiniBand (IB) provides a hardware message passing mechanism which can be used for Input/Output devices (I/O) and Interprocess Communications (IPC) between general computing nodes. Consumers access IB message passing hardware by posting send/receive messages to send/receive work queues on an IB Channel Adapter (CA). The send/receive work queues (WQ) are assigned to a consumer as a Queue Pair (QP). Consumers retrieve the results of these messages from a Completion Queue (CQ) through IB send and receive work completions (WC).

The source CA takes care of segmenting outbound messages and sending them to the destination. The destination CA takes care of reassembling inbound messages and placing them in the memory space designated by the destination's consumer. There are two CA types: Host CA and Target CA. The Host CA is used by general purpose computing nodes to access the IB fabric. Consumers use IB verbs to access Host CA functions. The software that interprets verbs and directly accesses the CA is known as the Channel Interface (CI).

An efficient mechanism is needed to pass work requests from the consumer to the CA hardware. In addition, a similar mechanism is needed for the CA hardware to pass work completions to the consumer. Therefore, it would be advantageous to have such a method, apparatus, and program to pass work requests from the consumer to the CA hardware and to pass work completions to the consumer, along with several optimization techniques.

### SUMMARY OF THE INVENTION

The present invention provides a distributed computing system having (host and I/O) end nodes, switches, routers, and links interconnecting these components. The end nodes use send and receive queue pairs to transmit and receive messages. The end nodes use completion queues to inform the end user when a message has been completely sent or received and whether an error occurred during the message transmission or reception process. The present invention describes a mechanism for implementing these queue pairs and completion queues in hardware. A method for controlling the transfer of work requests from the consumer to the CA hardware using only head pointers in the hardware is described, along with a method for passing work completions from the CA hardware to the consumer using only tail pointers in the hardware. With this scheme the CA hardware can inform the CI that a work request has been completed and provide the work completion information with just a single write to system memory. Additionally, several mechanisms are provided which can be used to improve the overall efficiency of this process under different memory configurations.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system is illustrated in accordance with a preferred embodiment of the present invention;

FIG. 2 is a functional block diagram of a host processor node in accordance with a preferred embodiment of the present invention;

FIG. 3A is a diagram of a host channel adapter in accordance with a preferred embodiment of the present invention;

FIG. 3B is a diagram of a switch in accordance with a preferred embodiment of the present invention;

FIG. 3C is a diagram of a router in accordance with a preferred embodiment of the present invention;

FIG. 4 is a diagram illustrating processing of work requests in accordance with a preferred embodiment of the present invention;

FIG. 5 is a diagram illustrating a portion of a distributed computer system in accordance with a preferred embodiment of the present invention in which a reliable connection service is used;

FIG. 6 is a diagram illustrating a portion of a distributed computer system in accordance with a preferred embodiment of the present invention in which reliable datagram service connections are used;

FIG. 7 is an illustration of a data packet in accordance with a preferred embodiment of the present invention;

FIG. 8 is a diagram illustrating a portion of a distributed computer system in accordance with a preferred embodiment of the present invention;

FIG. 9 is a diagram illustrating the network addressing used in a distributed networking system in accordance with the present invention;

FIG. 10 is a diagram illustrating a portion of a distributed computing system in accordance with a preferred embodiment of the present invention in which the structure of SAN fabric subnets is illustrated;

FIG. 11 is a diagram of a layered communication architecture used in a preferred embodiment of the present invention;

FIG. 12 is a diagram showing an example implementation of a work queue using only head pointers in the hardware to access the queue using a combination of page pointers, indices, and adders in accordance with a preferred embodiment of the present invention;

FIG. 13 is a diagram showing an example implementation of a completion queue using only tail pointers in the hardware to access the queue using a combination of page pointers, indices, and adders in accordance with a preferred embodiment of the present invention;

FIG. 14 is a flowchart illustrating the operation of a channel interface when a consumer posts a work request to a work queue in accordance with a preferred embodiment of the present invention;

FIG. 15 is a flowchart illustrating the operation of a host channel adapter in accordance with a preferred embodiment of the present invention; and

FIG. 16 is a flowchart depicting the operation of a channel interface when a consumer has requested work completion information in accordance with a preferred embodiment of the present invention.

### DETAILED DESCRIPTION OF THE PREFERRED EMBODIMENT

The present invention provides an apparatus and method for managing work and completion queues using head pointers in the hardware for work queues and tail pointers in the hardware for completion queues. The present invention may be implemented in hardware, software, or a combination of hardware and software. The present invention is preferably implemented in a distributed computing system, such as a system area network (SAN) having end nodes, switches, routers, and links interconnecting these components. Each end node uses send and receive queue pairs to transmit and receives messages. The end nodes segment the message into packets and transmit the packets over the links. The switches and routers interconnect the end nodes and route the packets to the appropriate end node. The end nodes reassemble the packets into a message at the destination.

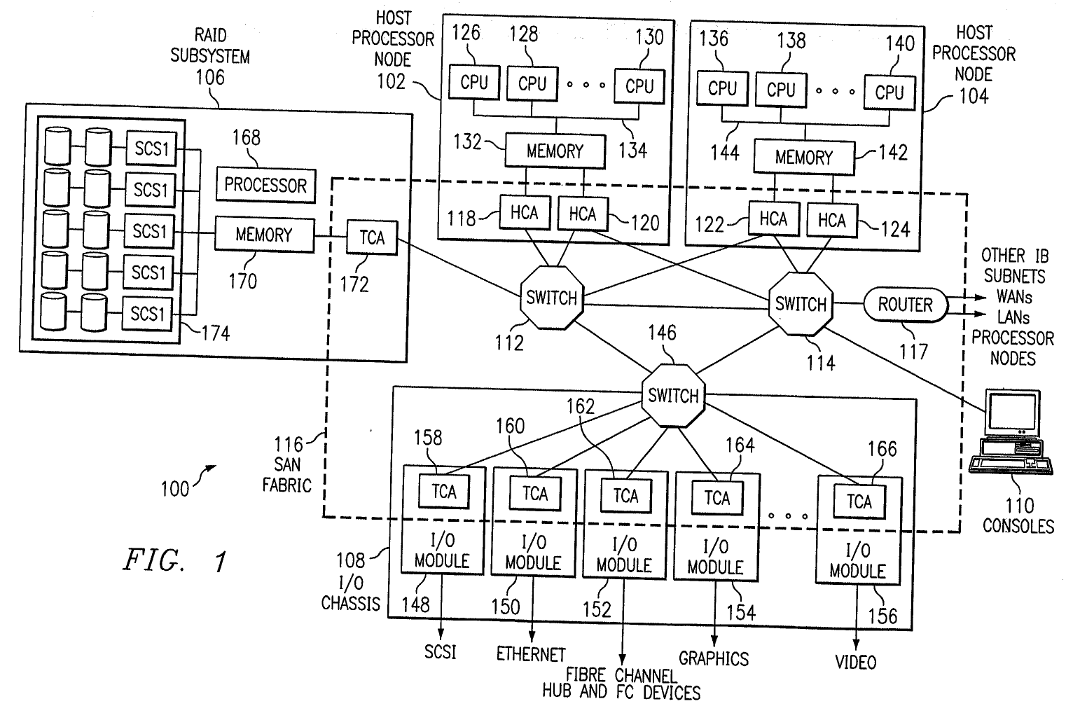

FIG. 1 is a diagram of a distributed computer system in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an Internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or frames in SAN 100.

In one embodiment of the present invention, an error handling mechanism in distributed computer systems is present in which the error handling mechanism allows for reliable connection or reliable datagram communication between end nodes in distributed computing system, such as SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the frame through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 116. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers. The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in distributed computer system. With an I/O adapter attached to the SAN 100, the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computed system are not required to use physical addressing for any operations.

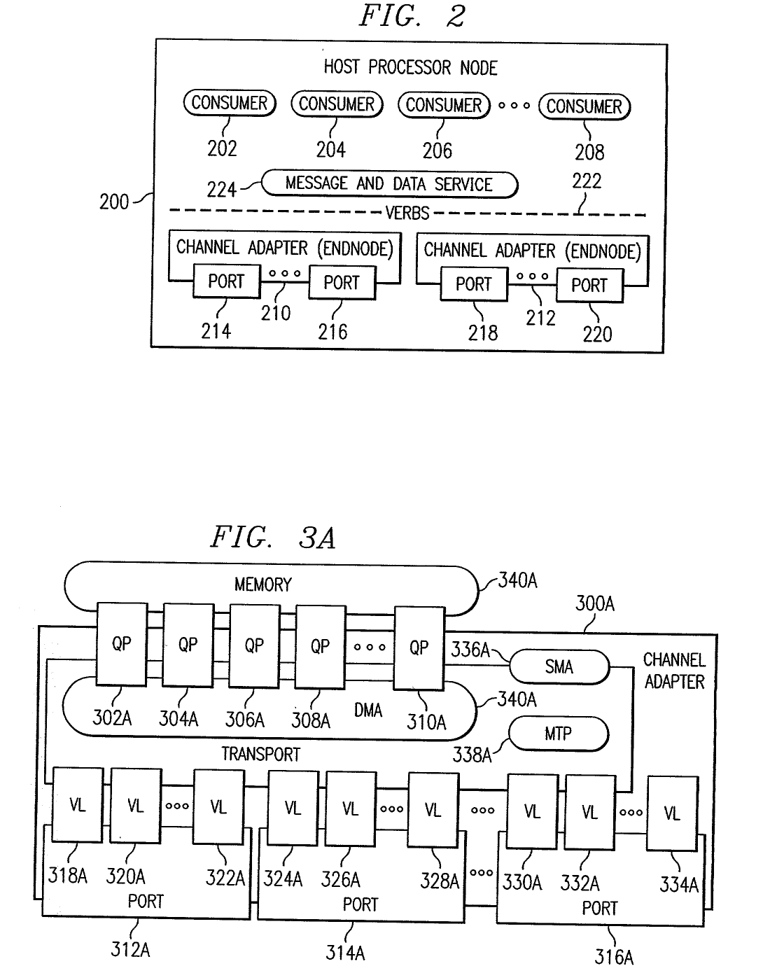

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through channel adapter 210 and channel adapter 212. Message and data service 224 provides an interface to consumers 202-208 to process messages and other data.

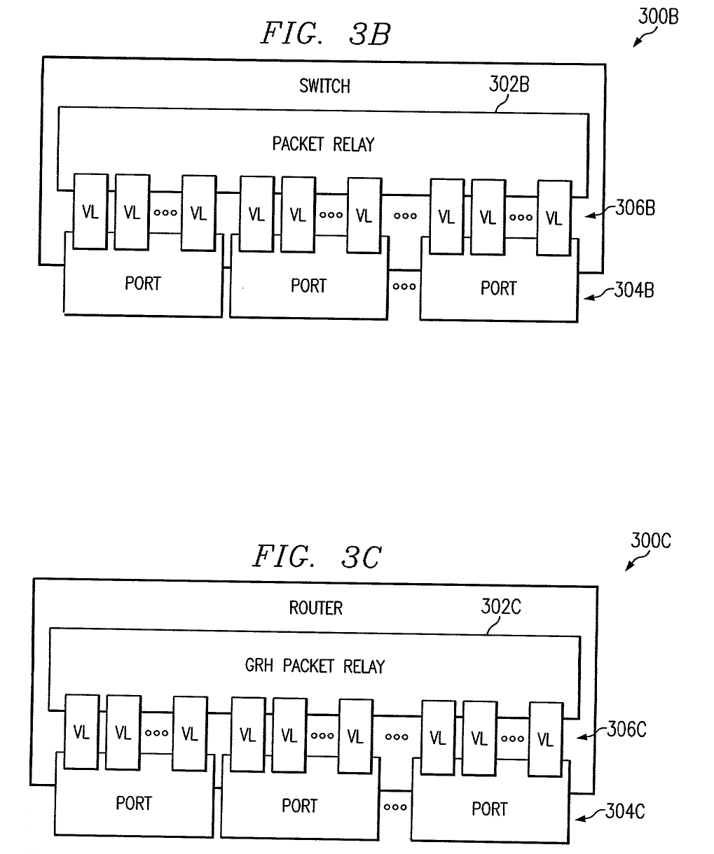

With reference now to FIG. 3A, a diagram of a host channel adapter is depicted in accordance with a preferred embodiment of the present invention. Host channel adapter 300A shown in FIG. 3A includes a set of queue pairs (QPs) 302A-310A, which are used to transfer messages to the host channel adapter ports 312A-316A. Buffering of data to host channel adapter ports 312A-316A is channeled through virtual lanes (VL) 318A-334A where each VL has its own flow control. Subnet manager configures channel adapters with the local addresses for each physical port, i.e., the port's LID. Subnet manager agent (SMA) 336A is the entity that communicates with the subnet manager for the purpose of configuring the channel adapter. Memory translation and protection (MTP) 338A is a mechanism that translates virtual addresses to physical addresses and validates access rights. Direct memory access (DMA) 340A provides for direct memory access operations using memory 340A with respect to queue pairs 302A-310A.

A single channel adapter, such as the host channel adapter 300A shown in FIG. 3A, can support thousands of queue pairs. By contrast, a target channel adapter in an I/O adapter typically supports a much smaller number of queue pairs. Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a packet relay 302B in communication with a number of ports 304B through virtual lanes such as virtual lane 306B. Generally, a switch such as switch 300B can route packets from one port to any other port on the same switch.

Similarly, FIG. 3C depicts a router 300C according to a preferred embodiment of the present invention. Router 300C includes a packet relay 302C in communication with a number of ports 304C through virtual lanes such as virtual lane 306C. Like switch 300B, router 300C will generally be able to route packets from one port to any other port on the same router.

Channel adapters, switches, and routers employ multiple virtual lanes within a single physical link. As illustrated in FIGS. 3A, 3B, and 3C, physical ports connect endnodes, switches, and routers to a subnet. Packets injected into the SAN fabric follow one or more virtual lanes from the packet's source to the packet's destination. The virtual lane that is selected is mapped from a service level associated with the packet. At any one time, only one virtual lane makes progress on a given physical link. Virtual lanes provide a technique for applying link level flow control to one virtual lane without affecting the other virtual lanes. When a packet on one virtual lane blocks due to contention, quality of service (QoS), or other considerations, a packet on a different virtual lane is allowed to make progress. Virtual lanes are employed for numerous reasons, some of which are as follows:

Virtual lanes provide QoS. In one example embodiment, certain virtual lanes are reserved for high priority or isochronous traffic to provide QoS.

Virtual lanes provide deadlock avoidance. Virtual lanes allow topologies that contain loops to send packets across all physical links and still be assured the loops won't cause back pressure dependencies that might result in deadlock.

Virtual lanes alleviate head-of-line blocking. When a switch has no more credits available for packets that utilize a given virtual lane, packets utilizing a different virtual lane that has sufficient credits are allowed to make forward progress.

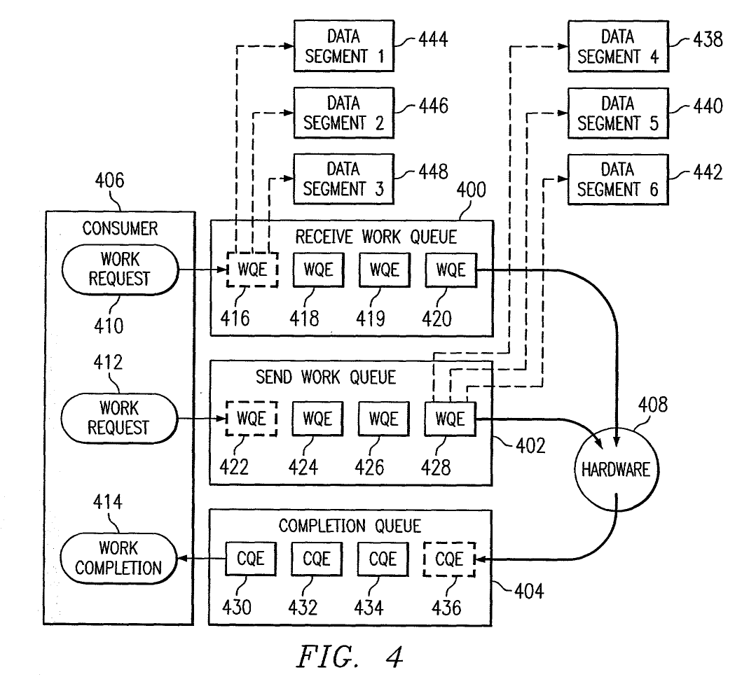

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains a virtually contiguous memory space. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. For example, work queue element 416 in receive work queue 400 references data segment 1 444, data segment 2 446, and data segment 3 448. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal. A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports four types of transport services: reliable connection, unreliable connection, reliable datagram, and unreliable datagram connection service.

Reliable and Unreliable connected services associate a local queue pair with one and only one remote queue pair. Connected services require a process to create a queue pair for each process that is to communicate with over the SAN fabric. Thus, if each of N host processor nodes contain P processes, and all P processes on each node wish to communicate with all the processes on all the other nodes, each host processor node requires P²×(N−1) queue pairs. Moreover, a process can connect a queue pair to another queue pair on the same host channel adapter.

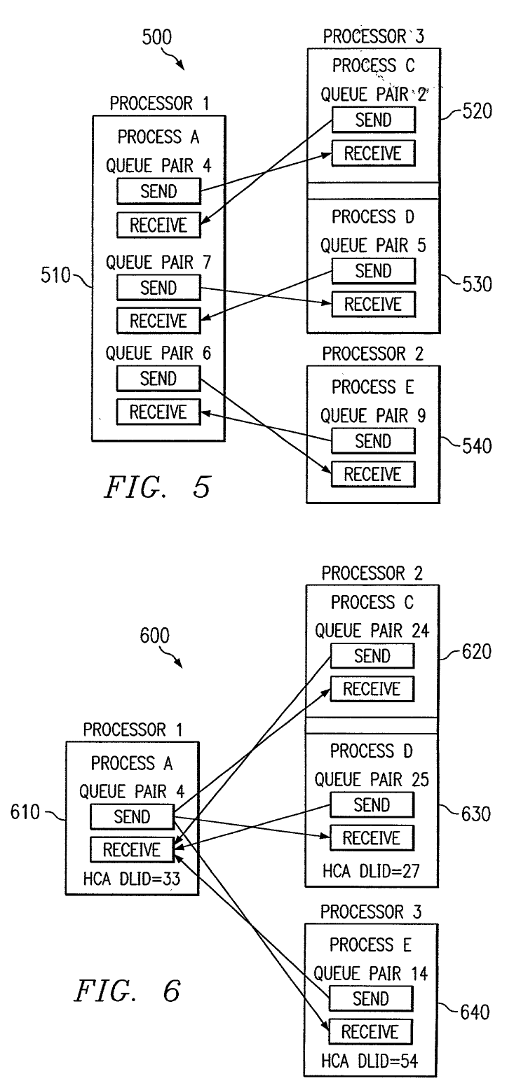

A portion of a distributed computer system employing a reliable connection service to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 3 includes a process C 520 and a process D 530. Host processor node 2 includes a process E 540.

Host processor node 1 includes queue pairs 4, 6 and 7, each having a send work queue and receive work queue. Host processor node 2 has a queue pair 9 and host processor node 3 has queue pairs 2 and 5. The reliable connection service of distributed computer system 500 associates a local queue pair with one and only one remote queue pair. Thus, the queue pair 4 is used to communicate with queue pair 2; queue pair 7 is used to communicate with queue pair 5; and queue pair 6 is used to communicate with queue pair 9.

A WQE placed on one queue pair in a reliable connection service causes data to be written into the receive memory space referenced by a Receive WQE of the connected queue pair. RDMA operations operate on the address space of the connected queue pair.

In one embodiment of the present invention, the reliable connection service is made reliable because hardware maintains sequence numbers and acknowledges all packet transfers. A combination of hardware and SAN driver software retries any failed communications. The process client of the queue pair obtains reliable communications even in the presence of bit errors, receive underruns, and network congestion. If alternative paths exist in the SAN fabric, reliable communications can be maintained even in the presence of failures of fabric switches, links, or channel adapter ports.

In addition, acknowledgments may be employed to deliver data reliably across the SAN fabric. The acknowledgment may, or may not, be a process level acknowledgment, i.e. an acknowledgment that validates that a receiving process has consumed the data. Alternatively, the acknowledgment may be one that only indicates that the data has reached its destination.

Reliable datagram service associates a local end-to-end (EE) context with one and only one remote end-to-end context. The reliable datagram service permits a client process of one queue pair to communicate with any other queue pair on any other remote node. At a receive work queue, the reliable datagram service permits incoming messages from any send work queue on any other remote node.

The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

A portion of a distributed computer system employing a reliable datagram service to communicate between distributed processes is illustrated in FIG. 6. The distributed computer system 600 in FIG. 6 includes a host processor node 1, a host processor node 2, and a host processor node 3. Host processor node 1 includes a process A 610 having a queue pair 4. Host processor node 2 has a process C 620 having a queue pair 24 and a process D 630 having a queue pair 25. Host processor node 3 has a process E 640 having a queue pair 14.

In the reliable datagram service implemented in the distributed computer system 600, the queue pairs are coupled in what is referred to as a connectionless transport service. For example, a reliable datagram service couples queue pair 4 to queue pairs 24, 25 and 14. Specifically, a reliable datagram service allows queue pair 4's send work queue to reliably transfer messages to receive work queues in queue pairs 24, 25 and 14. Similarly, the send queues of queue pairs 24, 25, and 14 can reliably transfer messages to the receive work queue in queue pair 4.

In one embodiment of the present invention, the reliable datagram service employs sequence numbers and acknowledgments associated with each message frame to ensure the same degree of reliability as the reliable connection service. End-to-end (EE) contexts maintain end-to-end specific state to keep track of sequence numbers, acknowledgments, and time-out values. The end-to-end state held in the EE contexts is shared by all the connectionless queue pairs communication between a pair of endnodes. Each endnode requires at least one EE context for every endnode it wishes to communicate with in the reliable datagram service (e.g., a given endnode requires at least N EE contexts to be able to have reliable datagram service with N other endnodes).

The unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

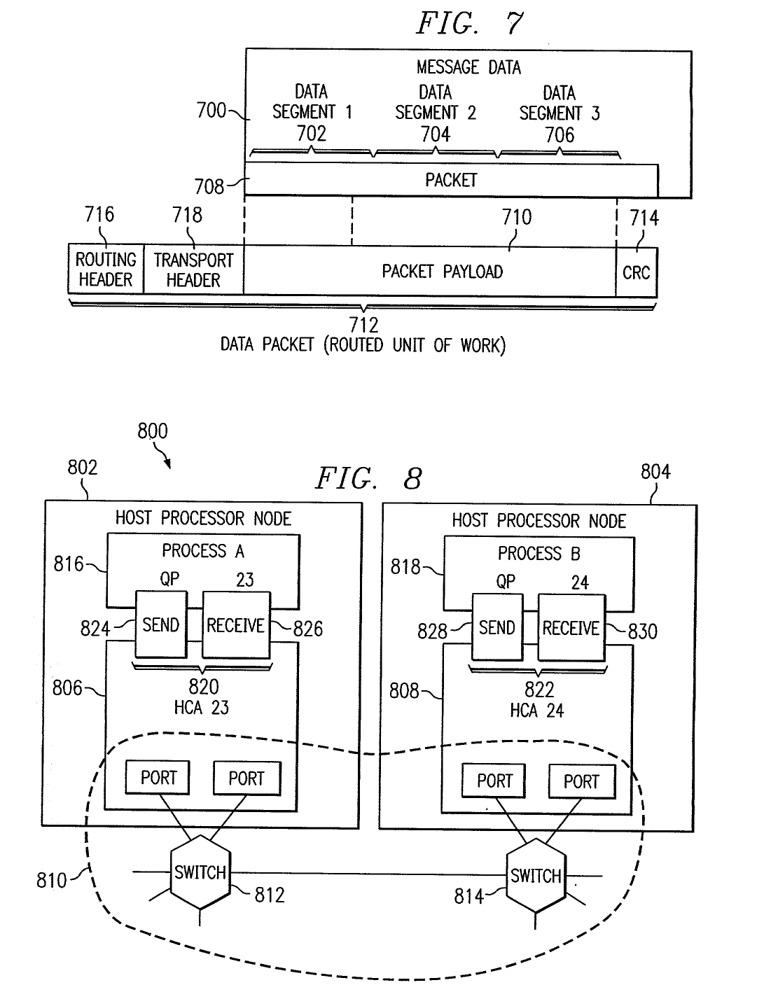

Turning next to FIG. 7, an illustration of a data packet is depicted in accordance with a preferred embodiment of the present invention. A data packet is a unit of information that is routed through the SAN fabric. The data packet is an endnode-to-endnode construct, and is thus created and consumed by endnodes. For packets destined to a channel adapter (either host or target), the data packets are neither generated nor consumed by the switches and routers in the SAN fabric. Instead for data packets that are destined to a channel adapter, switches and routers simply move request packets or acknowledgment packets closer to the ultimate destination, modifying the variant link header fields in the process. Routers, also modify the packet's network header when the packet crosses a subnet boundary. In traversing a subnet, a single packet stays on a single service level.

Message data 700 contains data segment 1 702, data segment 2 704, and data segment 3 706, which are similar to the data segments illustrated in FIG. 4. In this example, these data segments form a packet 708, which is placed into packet payload 710 within data packet 712. Additionally, data packet 712 contains CRC 714, which is used for error checking. Additionally, routing header 716 and transport 718 are present in data packet 712. Routing header 716 is used to identify source and destination ports for data packet 712. Transport header 718 in this example specifies the destination queue pair for data packet 712. Additionally, transport header 718 also provides information such as the operation code, packet sequence number, and partition for data packet 712.

The operating code identifies whether the packet is the first, last, intermediate, or only packet of a message. The operation code also specifies whether the operation is a send, RDMA write, RDMA read, or atomic. The packet sequence number is initialized when communication is established and increments each time a queue pair creates a new packet. Ports of an endnode may be configured to be members of one or more possibly overlapping sets called partitions.

In FIG. 8, a portion of a distributed computer system is depicted to illustrate an example request and acknowledgment transaction. The distributed computer system in FIG. 8 includes a host processor node 802 and a host processor node 804. Host processor node 802 includes a host channel adapter 806. Host processor node 804 includes a host channel adapter 808. The distributed computer system in FIG. 8 includes a SAN fabric 810, which includes a switch 812 and a switch 814. The SAN fabric includes a link coupling host channel adapter 806 to switch 812; a link coupling switch 812 to switch 814; and a link coupling host channel adapter 808 to switch 814.

In the example transactions, host processor node 802 includes a client process A. Host processor node 804 includes a client process B. Client process A interacts with host channel adapter hardware 806 through queue pair 23 (824 and 826). Client process B interacts with hardware channel adapter hardware 808 through queue pair 24 (828 and 830). Queue pairs 23 and 24 are data structures that include a send work queue and a receive work queue. Process A initiates a message request by posting work queue elements to the send queue 824 of queue pair 23. Such a work queue element is illustrated in FIG. 4. The message request of client process A is referenced by a gather list contained in the send work queue element. Each data segment in the gather list points to a virtually contiguous local memory space, which contains a part of the message, such as indicated by data segments 1, 2, and 3, which respectively hold message parts 1, 2, and 3, in FIG. 4. Hardware in host channel adapter 806 reads the work queue element and segments the message stored in virtual contiguous buffers into data packets, such as the data packet illustrated in FIG. 7. Data packets are routed through the SAN fabric, and for reliable transfer services, are acknowledged by the final destination endnode. If not successively acknowledged, the data packet is retransmitted by the source endnode. Data packets are generated by source endnodes and consumed by destination endnodes.

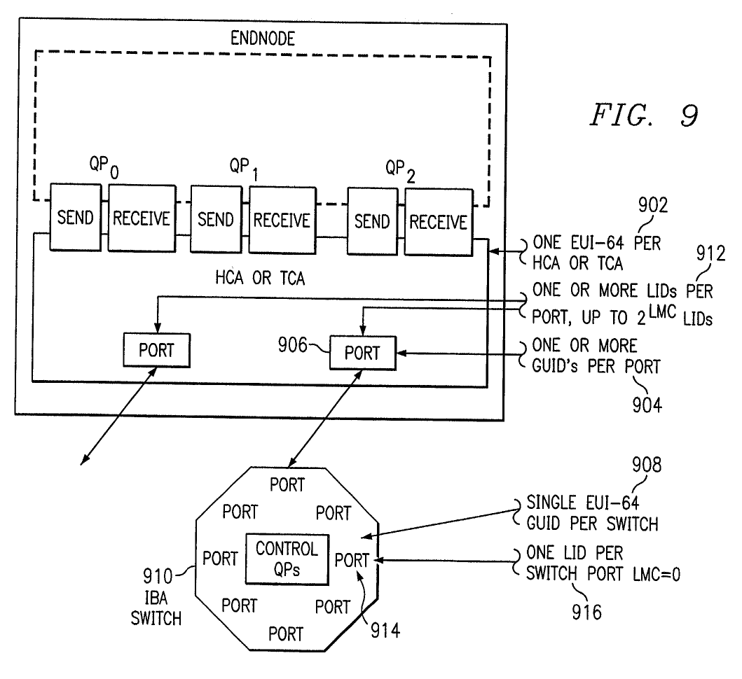

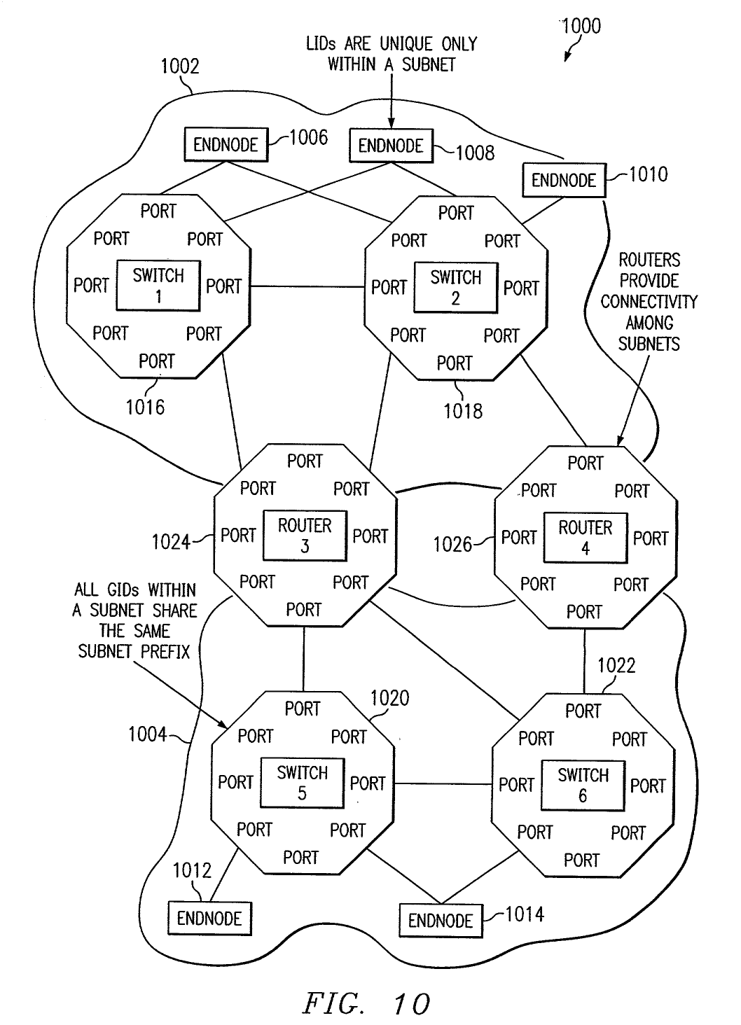

In reference to FIG. 9, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an end node specified by the host name. Thus, there is one host name per node, but a node can have multiple CAs. A single IEEE assigned 64-bit identifier (EUI-64) 902 is assigned to each component. A component can be a switch, router, or CA.

One or more globally unique ID (GUID) identifiers 904 are assigned per CA port 906. Multiple GUIDs (a.k.a. IP addresses) can be used for several reasons, some of which are illustrated by the following examples. In one embodiment, different IP addresses identify different partitions or services on an end node. In a different embodiment, different IP addresses are used to specify different Quality of Service (QoS) attributes. In yet another embodiment, different IP addresses identify different paths through intra-subnet routes.

One GUID 908 is assigned to a switch 910.

A local ID (LID) refers to a short address ID used to identify a CA port within a single subnet. In one example embodiment, a subnet has up to 2¹⁶ end nodes, switches, and routers, and the LID is accordingly 16 bits. A source LID (SLID) and a destination LID (DLID) are the source and destination LIDs used in a local network header. A single CA port 906 has up to 2^{LMC} LIDs 912 assigned to it. The LMC represents the LID Mask Control field in the CA. A mask is a pattern of bits used to accept or reject bit patterns in another set of data.

Multiple LIDs can be used for several reasons some of which are provided by the following examples. In one embodiment, different LIDs identify different partitions or services in an end node. In another embodiment, different LIDs are used to specify different QoS attributes. In yet a further embodiment, different LIDs specify different paths through the subnet. A single switch port 914 has one LID 916 associated with it.

A one-to-one correspondence does not necessarily exist between LIDs and GUIDs, because a CA can have more or less LIDs than GUIDs for each port. For CAs with redundant ports and redundant conductivity to multiple SAN fabrics, the CAs can, but are not required to, use the same LID and GUID on each of its ports.

A portion of a distributed computer system in accordance with a preferred embodiment of the present invention is illustrated in FIG. 10. Distributed computer system 1000 includes a subnet 1002 and a subnet 1004. Subnet 1002 includes host processor nodes 1006, 1008, and 1010. Subnet 1004 includes host processor nodes 1012 and 1014. Subnet 1002 includes switches 1016 and 1018. Subnet 1004 includes switches 1020 and 1022.

Routers connect subnets. For example, subnet 1002 is connected to subnet 1004 with routers 1024 and 1026. In one example embodiment, a subnet has up to 2¹⁶ endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the DLID that is unique within the subnet to permit the switch to quickly and efficiently route incoming message packets. In one embodiment, the switch is a relatively simple circuit, and is typically implemented as a single integrated circuit. A subnet can have hundreds to thousands of endnodes formed by cascaded switches.

As illustrated in FIG. 10, for expansion to much larger systems, subnets are connected with routers, such as routers 1024 and 1026. The router interprets the IP destination ID (e.g., IPv6 destination ID) and routes the IP-like packet.

An example embodiment of a switch is illustrated generally in FIG. 3B. Each I/O path on a switch or router has a port. Generally, a switch can route packets from one port to any other port on the same switch.

Within a subnet, such as subnet 1002 or subnet 1004, a path from a source port to a destination port is determined by the LID of the destination host channel adapter port. Between subnets, a path is determined by the IP address (e.g., IPv6 address) of the destination host channel adapter port and by the LID address of the router port which will be used to reach the destination's subnet.

In one embodiment, the paths used by the request packet and the request packet's corresponding positive acknowledgment (ACK) or negative acknowledgment (NAK) frame are not required to be symmetric. In one embodiment employing certain routing, switches select an output port based on the DLID. In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses host channel adapter hardware through one or more queue pairs, such as the queue pairs illustrated in FIGS. 3A, 5, and 6. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, channel adapter hardware detects work queue element postings and accesses the work queue element. In this embodiment, the channel adapter hardware translates and validates the work queue element's virtual addresses and accesses the data.

An outgoing message is split into one or more data packets. In one embodiment, the channel adapter hardware adds a transport header and a network header to each packet. The transport header includes sequence numbers and other transport information. The network header includes routing information, such as the destination IP address and other network routing information. The link header contains the Destination Local Identifier (DLID) or other local routing information. The appropriate link header is always added to the packet. The appropriate global network header is added to a given packet if the destination endnode resides on a remote subnet.

If a reliable transport service is employed, when a request data packet reaches its destination endnode, acknowledgment data packets are used by the destination endnode to let the request data packet sender know the request data packet was validated and accepted at the destination. Acknowledgment data packets acknowledge one or more valid and accepted request data packets. The requester can have multiple outstanding request data packets before it receives any acknowledgments. In one embodiment, the number of multiple outstanding messages, i.e. Request data packets, is determined when a queue pair is created.

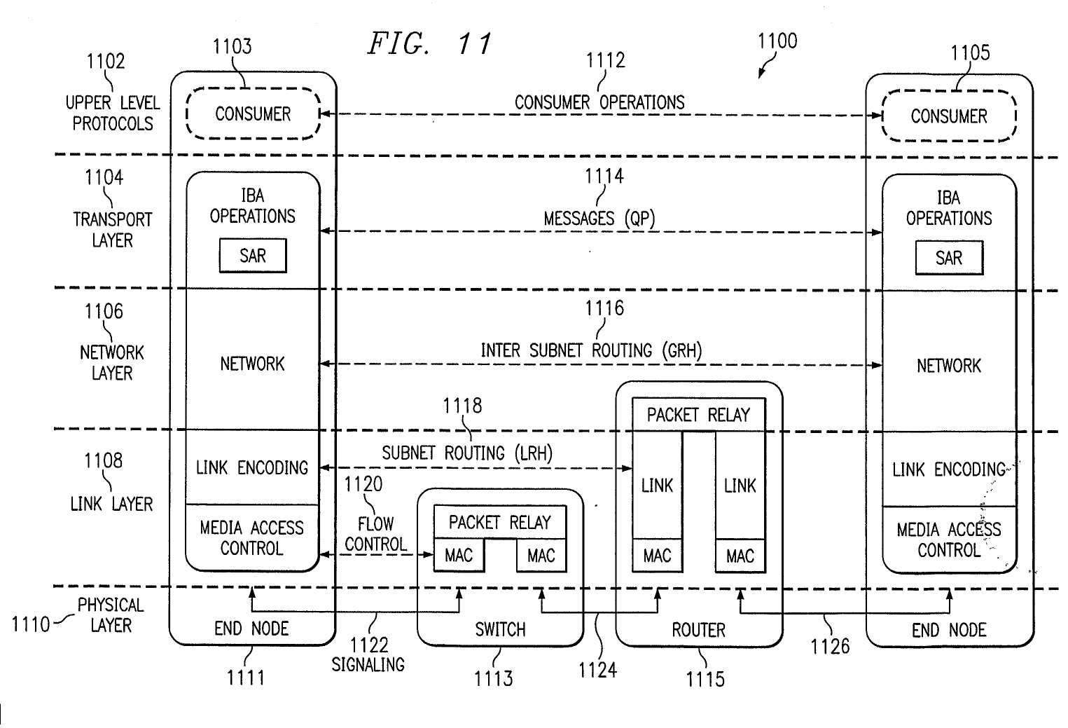

One embodiment of a layered architecture 1100 for implementing the present invention is generally illustrated in diagram form in FIG. 11. The layered architecture diagram of FIG. 11 shows the various layers of data communication paths, and organization of data and control information passed between layers.

Host channel adapter endnode protocol layers (employed by endnode 1111, for instance) include an upper level protocol 1102 defined by consumer 1103, a transport layer 1104; a network layer 1106, a link layer 1108, and a physical layer 1110. Switch layers (employed by switch 1113, for instance) include link layer 1108 and physical layer 1110. Router layers (employed by router 1115, for instance) include network layer 1106, link layer 1108, and physical layer 1110.

Layered architecture 1100 generally follows an outline of a classical communication stack. With respect to the protocol layers of end node 1111, for example, upper layer protocol 1102 employs verbs to create messages at transport layer 1104. Network layer 1106 routes packets between network subnets (1116). Link layer 1108 routes packets within a network subnet (1118). Physical layer 1110 sends bits or groups of bits to the physical layers of other devices. Each of the layers is unaware of how the upper or lower layers perform their functionality.

Consumers 1103 and 1105 represent applications or processes that employ the other layers for communicating between endnodes. Transport layer 1104 provides end-to-end message movement. In one embodiment, the transport layer provides four types of transport services as described above which are reliable connection service; reliable datagram service; unreliable datagram service; and raw datagram service. Network layer 1106 performs packet routing through a subnet or multiple subnets to destination endnodes. Link layer 1108 performs flow-controlled, error checked, and prioritized packet delivery across links.

Physical layer 1110 performs technology-dependent bit transmission. Bits or groups of bits are passed between physical layers via links 1122, 1124, and 1126. Links can be implemented with printed circuit copper traces, copper cable, optical cable, or with other suitable links.

The present invention operates within the SAN environment described above with regard to FIGS. 1-11. The present invention provides a mechanism for managing work and completion queues in the SAN architecture using head and tail pointers. The description of the present invention will be provided for both the work and the completion queue in order to provide an understanding of how the head and tail pointers are used with each. It should be appreciated that the following descriptions of the operation of the present invention with the work and completion queues are exemplary and modifications may be made without departing from the spirit and scope of the present invention.

Work Queue Structure

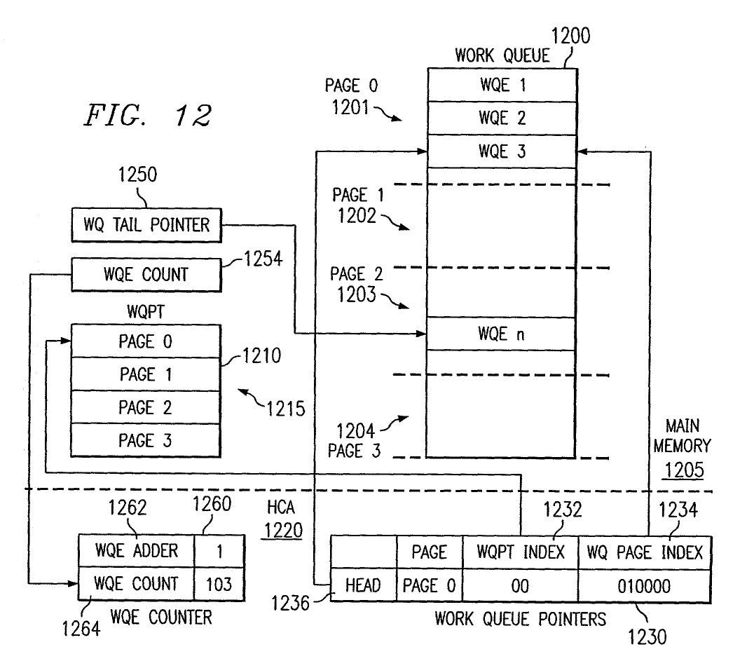

FIG. 12 shows an example work queue, which could be either a send queue or a receive queue. Work queue 1200 is made up of one or more pages, which are typically 4 Kbytes in size, although other sizes could be used. In the example in FIG. 12, the queue uses four pages, page 0 1201, page 1 1202, page 2 1203, and page 3 1204, located in system memory 1205. The WQE size is chosen such that the number of WQEs that fit within a page is a power of two. For example, with a 64 byte WQE, 64 WQEs would fit in a 4K page. In the example in FIG. 12, this would provide a queue depth of 256 WQEs. Different queue depths can be provided by changing the number of pages that make up the work queue. The hardware is simplified by making this number of pages a power of two, while still maintaining significant flexibility in the choice of size of work queue.

A Work Queue Page Table (WQPT) 1210 is maintained, that contains a list 1215 of pages that make up the work queue. This may be located in system memory or HCA memory, but in either case its location is stored in the HCA 1220. The HCA maintains two indices for the work queue pointer 1230 for each work queue. The first, WQPT index 1232, is used to index into the aforementioned WQPT. In the example in FIG. 12, which has a work queue comprised of four pages, the WQPT index is two bits. The second index is WQ Page Index 1234, which is used to index into each page of the work queue. For example, with a 64 byte WQE and a 4K page, the WQ Page Index would be 6 bits.

For a work queue the CI maintains a tail pointer 1250 and the HCA maintains a head pointer 1236. The tail pointer maintained by the CI points to the location on the work queue at which the next WQE will be placed. The head pointer maintained by the HCA, points to the location on the work queue of the next WQE to be processed.

The HCA maintains a WQE counter 1260 of the number of WQEs on the queue, and provides a facility to allow the CI to increment this count when a WQE is posted to the queue using WQE adder 1262. The CI also maintains a count 1254 of the number of WQEs on the work queue. The CI increments its WQE count 1254 by one when it enqueues a WQE and decrements it by one when a WQE has been confirmed to have been processed, by retrieving its associated CQE from the CQ. The HCA increments its WQE count 1264 by the number written to the WQE adder 1262 by the CI when the CI enqueues that number of WQEs. The HCA decrements its WQE count 1264 by one when a WQE has been processed.

The initial state of the WQ is empty whereby head index 1236 maintained by the HCA is equal to tail index 1250 that is maintained by the CI and both reference the top of the queue. In addition the WQE count maintained by both the HCA and the CI is zero.

Completion Queue Structure

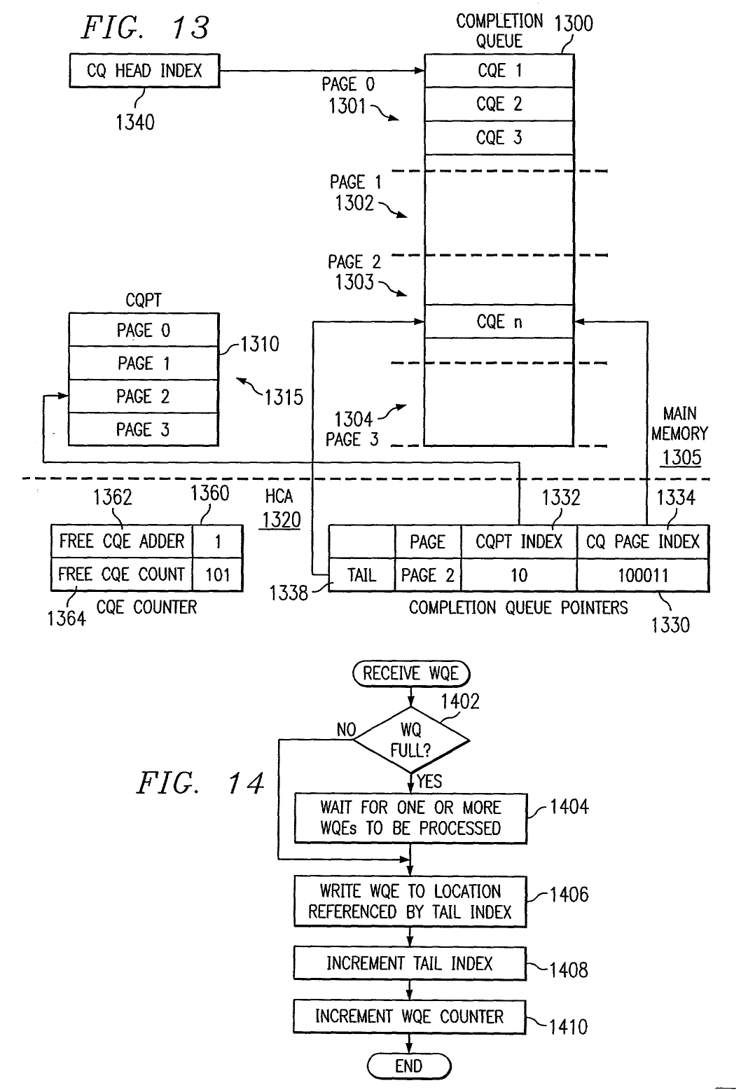

FIG. 13 shows an example completion queue. Completion queue 1300 is made up of one or more pages, which are typically 4 Kbytes in size, although other sizes could be used. In the example in FIG. 13, the queue uses four pages, page 0 1301, page 1 1302, page 2 1303, and page 3 1304 located in system memory 1305. The CQE size is chosen such that the number of CQEs that fit within a page is a power of two. For example, with a 64 byte CQE, 64 CQEs would fit in a 4K page. In the example in FIG. 13, this would provide a queue depth of 256 CQEs. Different queue depths can be provided by changing the number of pages that make up the CQ. The hardware is simplified by making this number of pages a power of two, while still maintaining significant flexibility in the choice of size of completion queue.

A Completion Queue Page Table (CQPT) 1310 is maintained, that contains a list 1315 of pages that make up the CQ. This may be located in system memory or HCA memory, but in either case its location is stored in the HCA 1320. The HCA maintains two indices for the completion queue pointer 1330 for each CQ. The first, CQPT index 1332, is used to index into the aforementioned CQPT. In the example in FIG. 13, which has a CQ comprised of four pages, the CQPT index is two bits. The second index is CQ Page Index 1334, which is used to index into each page of the CQ. For example, with a 64 byte CQE and a 4K page, the CQ Page Index would be 6 bits.

For a CQ the CI maintains head pointer 1340 and the HCA maintains a tail pointer 1338. The head pointer 1340 maintained by the CI points to the location on the completion queue of the next CQE to be processed. The tail pointer 1338 maintained by the HCA, points to the location on the completion queue at which the next CQE will be enqueued.

The Free CQE count is the number of empty slots available on the CQ. The HCA maintains a CQE counter 1360 and a facility that allows the CI to add to Free CQE count 1364 after a CQE has been processed using Free CQE adder 1362. The CI increments the Free CQE count 1364 by one when it processes a CQE. The CI instructs the HCA to perform this increment by writing one to the Free CQE Adder 1362. The HCA decrements its Free CQE count 1364 by one when a CQE is enqueued on the CQ.

The initial state of the CQ is empty whereby tail index 1338 maintained by the HCA is equal to head index 1340 maintained by the CI and both reference the top of the queue. In addition the Free CQE count maintained by the HCA is equal to the maximum number of CQEs capable of being stored on the CQ.

Detailed Work Request Operation

With reference to FIG. 14, a flowchart is shown illustrating the operation of a channel interface when a consumer posts a work request to a work queue in accordance with a preferred embodiment of the present invention. The process begins by receiving a work request and the CI checks if the work queue is full by comparing the CI's local copy of the WQE count with the maximum number of WQEs capable of being stored on the work queue (step 1402). If they are equal, the queue is full, so this work request is not accepted until the HCA indicates that one or more WQEs have been processed by posting one or more CQEs to the completion queue (step 1404). If the queue is not full in step 1402, the WQE is written to the location referenced by the tail index (step 1406).

The CI builds a WQE that defines the request and writes this WQE at the tail of the queue. The location of the tail is determined from the tail index, which is the combination of the WQPT index and the WQ Page index. The combination of the page address and the offset into the page provides the address at which the WQE is placed. Alternatively, if the work queue pages correspond to a contiguous virtual address space, the CI may maintain a WQ tail pointer that is a virtual address, and use hardware address translation to store the WQE at the appropriate location on the queue.

The tail index is then incremented so that it references the location at which the next WQE will be placed (step 1408). The CI then uses the HCA facility to increment the HCA's WQE count by one (step 1410), to inform the HCA that there is one or more WQEs on the work queue that need processing. The CI's local copy of the WQE count is also incremented. Thereafter, the process ends.

When the tail index is incremented, if the page index wraps, the WQPT index is incremented by one. If the WQPT index wraps, the work queue has wrapped to the top of the queue. While the CI is in the process of checking and updating the tail index and writing the WQE to the tail of the queue, it needs to obtain an exclusive lock of these resources to prevent them from being used by other processes.

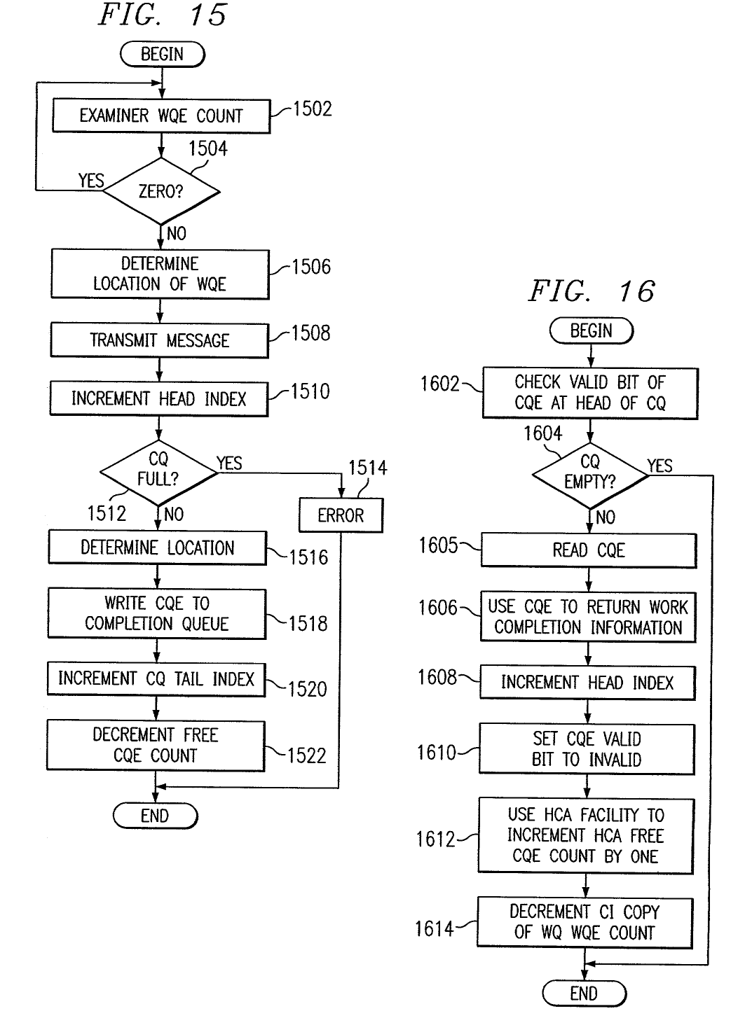

Turning now to FIG. 15, a flowchart illustrating the operation of a host channel adapter is shown in accordance with a preferred embodiment of the present invention. The process begins and the HCA monitors the work queue, by periodically checking the WQE count (step 1502). A determination is made as to whether the WQE count is zero (step 1504). If zero, the queue is empty and the process returns to step 1502 to examine the WQE count. If the WQE count is not zero in step 1504, there is a WQE to be processed, and the HCA transmits the message requested. Alternatively, when the CI uses the facility to add to the WQE count in the HCA, the HCA may use this as an indication that there is a WQE to be processed.

When there is a WQE to process, the HCA determines the location of the WQE (step 1506) by first locating the page that contains the WQE. This is done by indexing into the WQPT using the HCA's head WQPT index. The location within the page is then determined based on the WQ page index and the size of the WQE.

The process then transmits the message (step 1508). Any acknowledgments that may be required are received and the WQE processing is completed. The HCA increments its own copy of the head index (step 1510). When the head index is incremented, if the page index wraps, the WQPT index is incremented by one. If the WQPT index wraps, the work queue has wrapped to the top of the queue. The HCA also decrements its WQE count by one.

After the WQE processing has completed, the HCA notifies the CI by writing a CQE to the tail of the CQ. One of the fields in this CQE is a valid bit, that indicates to the CI that this is a valid CQE. Note that the hardware must guarantee all the other fields in the CQE have been written either before the valid bit is written or at the same time that it is written. Prior to writing the CQE, the HCA first checks that the CQ is not full by checking that the Free CQE count is not zero (step 1512). If it is zero, the CQ is full, and the operation is terminated in error (step 1514). If the CQ is not full in step 1512, the HCA determines the location at which to store the CQE by first locating the page using the HCA's tail CQPT index (step 1516). The location within the page is then determined based on the CQ page index and the size of the CQE and the process writes the CQE to the completion queue (step 1518). The HCA then increments its CQ tail index whereby, if the page index wraps, the CQPT index is incremented by one (step 1520). If the CQPT index wraps, the CQ tail has wrapped to the top of the queue. The HCA also decrements its Free CQE count by one (step 1522) and ends.

With reference now to FIG. 16, a flowchart is shown depicting the operation of a channel interface when a consumer has requested work completion information in accordance with a preferred embodiment of the present invention. The process begins and checks whether the CQE located at the head of the CQ has its valid bit set to indicate that it is valid (step 1602). The CI then determines whether the CQ is empty (step 1604). If the CQ is empty, the process ends. If the CQ is not empty in step 1604, the CI reads the CQE at the head of the CQ (step 1605). This CQE is referenced by the CQ head index in combination with the CQ page table. Alternatively, if the CQ pages correspond to a contiguous virtual address space, the CI may maintain a CQ head pointer that is a virtual address, and use hardware address translation to fetch the CQE from the appropriate location on the CQ. The contents of the CQE are then used to return the work completion information to the consumer that requested it (step 1606).

After the CQE has been processed by the CI, the CQ head index is incremented in a similar manner to the way in which the CI increments the WQ tail index (step 1608). The CI makes the CQE available for use by the HCA again by setting the valid bit in the CQE to indicate that it is not valid (step 1610). The CI then informs the HCA that the CQE has been processed by using the HCA facility to increment the HCA's Free CQE count by one (step 1612). In addition, the CI may now reclaim the WQE corresponding to this CQE by decrementing the CI's copy of the WQ WQE count by one (step 1614) and the process ends. The CI is required to perform this update of the WQE count to guarantee that there is a corresponding space on the CQ prior to freeing up the space on the work queue.

While the CI is in the process of checking and updating the CQ head index, reading the CQE from the head of the queue, and resetting the CQE valid bit, it needs to obtain an exclusive lock of these resources to prevent them from being used by other processes.

Optimizations

Following is a list of optimizations to the basic methodology described earlier in this disclosure:

1) The CI may reduce the number of writes to the HCA by updating the HCA's WQE count only once after several WQEs have been placed on the work queue and adding that number of WQEs that have been posted.

2) The CI may reduce the number of writes to the HCA by updating the HCA's Free CQE count only once after several CQEs have been retrieved from the CQ. In this case the CA needs to provide a mechanism to increment the free count by a variable number, n, instead of one.

3) If the work queue or CQ are contiguous in a virtual address space, the CI may reference that queue using the virtual address and using the hardware address translation mechanisms to perform the store or fetch. In this case the virtual address used to reference the queue would be incremented by the length of the WQE or CQE after the access and a check would be made against the virtual address of the end of the queue to detect when a wrap had occurred.

4) For work queues that fit within a single page, which may occur when the queue is small or the page size is large, the WQPT and the WQPT index may be eliminated. The real address of the single page would still need to be stored.

5) For CQs that fit within a single page, which may occur when the queue is small or the page size is large, the CQPT and the CQPT index may be eliminated. The real address of the single page would still need to be stored.

6) If the work queue is located in contiguous real memory, that is accessible by both the CI and the HCA, the WQPT and the WQPT index may be eliminated.

7) If the CQ is located in contiguous real memory, that is accessible by both the CI and the HCA, the CQPT and the CQPT index may be eliminated.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a queue, comprising:
generating a queue tail index in the channel interface;
generating a queue head index for the queue in a host channel adapter;
generating a queue entry count for the queue in the host channel adapter; and
controlling the queue using the head index, the tail index, and the queue entry count.

2. The method of claim 1, wherein the queue is a work queue, and wherein the queue entry count is used to determine if the work queue is full.

3. The method of claim 1, wherein the queue is a work queue, and wherein the queue tail index is used to determine a position in the work queue where a work queue entry may be written by the channel interface.

4. The method of claim 1, wherein the queue is a work queue, and wherein the queue head index is used to determine a work queue entry to be processed by the host channel adapter.

5. The method of claim 1, wherein the queue is a work queue, and wherein the queue entry count is used to determine if the work queue is empty.

6. The method of claim 1, wherein the queue head index is comprised of a queue pointer table index and a queue page index.

7. The method of claim 1, wherein the queue is a work queue, and wherein controlling the queue includes:
determining whether the work queue is full; and
accepting a work request if the work queue is not full.

8. The method of claim 7, wherein accepting the work request includes:
writing a work queue entry corresponding to the work request in a position of the work queue identified by the queue tail pointer;
incrementing the queue tail pointer; and
incrementing the queue entry count.

9. The method of claim 8, wherein updating the queue entry count is not performed for every increment of the queue tail pointer.

10. The method of claim 1, wherein the queue is a work queue, and wherein controlling the queue includes:
determining whether the work queue is empty;
processing, in the host channel adapter, a work queue entry corresponding to the queue head index if the work queue is not empty; and
posting a completion queue entry to a completion queue after processing of the work queue entry is complete.

11. A method for managing a queue, comprising:
generating a queue head index for the queue in a channel interface;
generating a queue tail index for the queue in a host channel adapter;
generating a free queue entry count for the queue in the host channel adapter; and
controlling the queue using the head index, the tail index, and the free queue entry count.

12. The method of claim 11, wherein the queue is a completion queue, and wherein the queue head index is used to identify a completion queue entry to be processed by the channel interface.

13. The method of claim 11, wherein the queue is a completion queue, and wherein the free queue entry count is used to determine if the completion queue is empty.

14. The method of claim 11, wherein the queue is a completion queue, and wherein the free queue entry count is used to determine if the completion queue is full.

15. The method of claim 11, wherein the queue is a completion queue, and wherein the queue tail index is used to identify a position in the completion queue where a completion queue entry may be written.

16. The method of claim 11, wherein the queue tail index is comprised of a queue pointer table index and a queue page index.

17. The method of claim 11, wherein the queue is a completion queue, and wherein controlling the queue includes:
determining whether the completion queue is full; and
writing a completion queue entry to a position of the completion queue identified by the queue tail index if the completion queue is not full.

18. The method of claim 17, wherein the queue is a completion queue, and wherein controlling the queue includes:
determining whether the completion queue is empty; and
processing a completion queue entry identified by the queue head index if the completion queue is not empty.

19. A computer program product, in a computer readable medium, for managing a queue, comprising:
instructions for generating a queue tail index in the channel interface;
instructions for generating a queue head index for the queue in a host channel adapter;
instructions for generating a queue entry count for the queue in the host channel adapter; and
instructions for controlling the queue using the head index, the tail index, and the queue entry count.

20. The computer program product of claim 19, wherein the queue is a work queue, and wherein the queue entry count is used to determine if the work queue is full.

21. The computer program product of claim 19, wherein the queue is a work queue, and wherein the queue entry count is used to determine if the work queue is empty.

22. The computer program product of claim 19, wherein the queue is a work queue, and wherein the instructions for controlling the queue include:
instructions for determining whether the work queue is full; and
instructions for accepting a work request if the work queue is not full.

23. The computer program product of claim 22, wherein the instructions for accepting the work request include:
instructions for writing a work queue entry corresponding to the work request in a position of the work queue identified by the queue tail pointer;
instructions for incrementing the queue tail pointer; and
instructions for incrementing the queue entry count.

24. The computer program product of claim 23, wherein the queue entry count is not updated for every increment of the queue tail pointer.

25. The computer program product of claim 19, wherein the queue is a work queue, and wherein the instructions for controlling the queue include:
instructions for determining whether the work queue is empty;
instructions for processing, in the host channel adapter, a work queue entry corresponding to the queue head index if the work queue is not empty; and
instructions for posting a completion queue entry to a completion queue after processing of the work queue entry is complete.

26. A computer program product, in a computer readable medium, for managing a queue, comprising:
instructions for generating a queue head index for the queue in a channel interface;
instructions for generating a queue head index for the queue in a host channel adapter;
instructions for generating a free queue entry count for the queue in the host channel adapter; and
instructions for controlling the queue using the head index, the tail index, and the free queue entry count.

27. The computer program product of claim 26, wherein the queue is a completion queue, and wherein the free queue entry count is used to determine if the completion queue is empty.

28. The computer program product of claim 26, wherein the queue is a completion queue, and wherein the free queue entry count is used to determine if the completion queue is full.

29. The computer program product of claim 26, wherein the queue is a completion queue, and wherein the instructions for controlling the queue include:
instructions for determining whether the completion queue is full; and
instructions for writing a completion queue entry to a position of the completion queue identified by the queue tail index if the completion queue is not full.

30. The computer program product of claim 29, wherein the queue is a completion queue, and wherein the instructions for controlling the queue include:
instructions for determining whether the completion queue is empty; and
instructions for processing a completion queue entry identified by the queue head index if the completion queue is not empty.

31. An apparatus for managing a work queue, comprising:
a channel interface; and
a host channel adapter coupled to the channel interface, wherein the channel interface includes a queue tail index for the queue, the host channel adapter includes a queue head index for the queue and a queue entry count for the queue, and wherein the host channel adapter and channel interface manage the queue using the head index, the tail index, and the queue entry count.

32. An apparatus for managing a completion queue, comprising:
a channel interface; and
a host channel adapter coupled to the channel interface, wherein the channel interface includes a queue head index for the queue, the host channel adapter includes a queue tail index for the queue and a queue entry count for the queue, and
wherein the host channel adapter and channel interface manage the queue using the head index, the tail index, and the queue entry count.
